(19) United States
(12) Patent Application Publication
(10) Pub. No.: US 2008/0041920 A1
(43) Pub. Date: Feb. 21, 2008

(54) ASSEMBLY FOR THE INTERCONNECTION OF AT LEAST TWO COMPONENTS BY MEANS OF AN ASSEMBLY AND A RECEPTACLE ELEMENT

(76) Inventors: Klaus Kirchhof, Niedernhausen (DE); Hans-Willi Stiep, Biebelsheim (DE)

Correspondence Address: Robert L. Stearns;Suite 2000, 38525 Woodward Avenue, Bloomfield Hills, MI, 48304-2970, US

(21) Appl. No.: 11/458,844

(22) Filed: Jul. 20, 2006

(51) Int. Cl. A47J 36/02

(52) U.S. Cl. 228/101

(57) ABSTRACT

An assembly for the interconnection of at least two components includes a press-station, a joining-station and a welding station. A receiver element with first base material and second receiver element with second base material is provided. In the press-station a first press assembly is located for pressing of the first component into the first receiver element. In the joining-station the first receiver element is interconnected with the second receiver element, where the base material interlock together. In the welding station, which is preferably a laser welding station, the two components are welded together with the two receiver elements.

### RELATED APPLICATIONS

1. Technical Field

The invention concerns an assembly for the interconnection of at least two components.

2. Related Art

This type of assembly is used in welding sockets having washer disks, for example. For this purpose corresponding mounts for the sockets and for the washer disks are necessary.

The manual effort for such assemblies is costly, because the service technician must manually insert parts and setup the assembly using hand tools.

### SUMMARY OF THE INVENTION

A purpose of this invention is therefore to prepare an assembly for the interconnection of at least two components, which does not require the use of manual tools for assembly.

This purpose is fulfilled with an assembly exhibiting the following characteristics:

A press-station with at least one receiver element with primary base unit material and with a first press assembly for pressing the first component into the first receiver element,

A joining station with at least a second receiver element with secondary base unit material to receive the second component with a second press assembly for pressing both units together onto a base, and

A welding station for welding the two components into the two receiver elements.

The advantage of this assembly is that the relevant component is pressed into a first receiver element by means of a press assembly. To do this all that is required is that the first component merely needs to be positioned onto the first receiver element. The second component is picked up from a second receiver element, preferably where this second component has been deposited.

To bring the components into their positions in which they are to be welded to each other, the receiver elements are connected to each other. For this purpose the receiver elements are pushed together in the joining station, and are pressed together in such a manner that the base material of the two receiver elements connect together.

Preferably the assembly features two receiver elements, which will be joined together in this manner. It is also possible to use multiple components with multiple receiver elements, where the base materials will be joined together.

More than one component can be accepted into a receiver element. If the first component is a friction bearing socket for example, the second component is a ring fence or the second components may consist of two or more washer disks, resulting in a ring fence.

The service personnel do not require manual tools, to install the components into the receiver elements, and to connect the receiver elements.

Ejection of the component elements after welding preferably occurs in the press-station.

The base material should preferably be formed from recesses in the receiver element, and from the thrust piece from the other receiver element taking hold in the recesses.

The first receiver element can be a ring-shaped journal bearing receiver, the second receiver element may be a ring-shaped thrust bearing receiver. The journal bearing receiver serves to receive a friction bearing socket and the thrust bearing receiver to receive a ring fence or a washer disk.

The first receiver element preferably exhibits a large diameter first receiving section and a small diameter adjoining second receiving section. Pressing of rolled sockets, for example into the receiver element is made easier by the two receiving sections. The smaller diameter receiving section hereby defined the final mass of the friction bearing socket.

The width B1 of the second receiving section should preferably be smaller than the width B2 of the first component. Thus the first component stands across from the first receiver element. Upon joining together with the second receiver element, the first component is pressed back by the second receiver element, so that we can ensure that the two components are properly placed in relationship to each other prior to executing the welding process step.

This requires a corresponding friction or clamping force so that the first component can be securely held in place while also ensuring that an adjustment within the first receiver element can be assured. To achieve this two implementations are foreseen.

In accordance with the first implementation form, the receiving sections are to be laid out in a radial form.

In this manner the first receiver element may exhibit a tension ring, having multiple interlocking, spring elements arranged adjoining each other.

In accordance with the second implementation form, at least one receiving section can exhibit an 0-Ring.

The base material can be spring thrust pieces with corresponding recesses in the form of one or more grooves.

For this the first receiver element will include an apron extending over the second receiver element, in which the spring thrust pieces are to be arranged facing inward. The second receiver element should preferably have a circumferential groove, into which the spring thrust pieces will take hold.

Preferably the spring thrust pieces will take hold excentrically into the groove. This excentral grip results in contact pressure for both receiver elements, and the previously mentioned push-back of the first component within the first receiver element.

The welding station should preferably include a laser.

Beyond this the welding station includes a table with a tray, into which the interconnected receiver elements may be placed. Also, no manual tools are required by the service personnel for this process step.

The axis of the table should preferably be aligned at an angle between 70° and 95° relative to the laser beam. To achieve this it is preferred that the laser be arranged above the table. It may be advantageous if the table is a turntable, which may rotate underneath the locally fixed laser. This implementation form saves space when compared to the other implementation options, where the laser moves relative to the table.

It is preferred that the assembly be used for the welding of friction bearing sockets with washer disk or ring fences.

The previously described first Receiver element exhibits a core body for clamping acceptance of a component, and is characterized by at least one receiving section in a spring form, which is vertical to the surface area of the component to be accepted, where a number of multiple interlocking, spring elements arranged adjoining each other.

Each spring element exhibits preferably two side pieces, where the free end of the first side piece is attached to the component to be connected and the end of the second side pieces is attached to the core body. The spring elements are U-shaped when seen in top view, so that they are spring-like in a radial direction.

### THE DRAWINGS

Exemplary implementation forms of this invention will be subsequently explained on the basis of the diagrams. They show:

FIG. 1 is a schematic representation showing the press-station and the joining-station;

FIG. 1b is an enlarged representation of the details of 1b in FIG. 1a;

FIG. 2 us a schematic representation showing the welding station;

FIGS. 3 and 4 are each sections cut through the first receiver element according to the second implementation form;

FIG. 5 is a top view of the receiver element in the direction of arrow 5 in FIG. 4;

FIG. 6 is an enlarged representation of detail VI of FIG. 5; and

FIG. 7 is a component part representation of the receiver elements according to FIG. 4.

### DETAILED DESCRIPTION

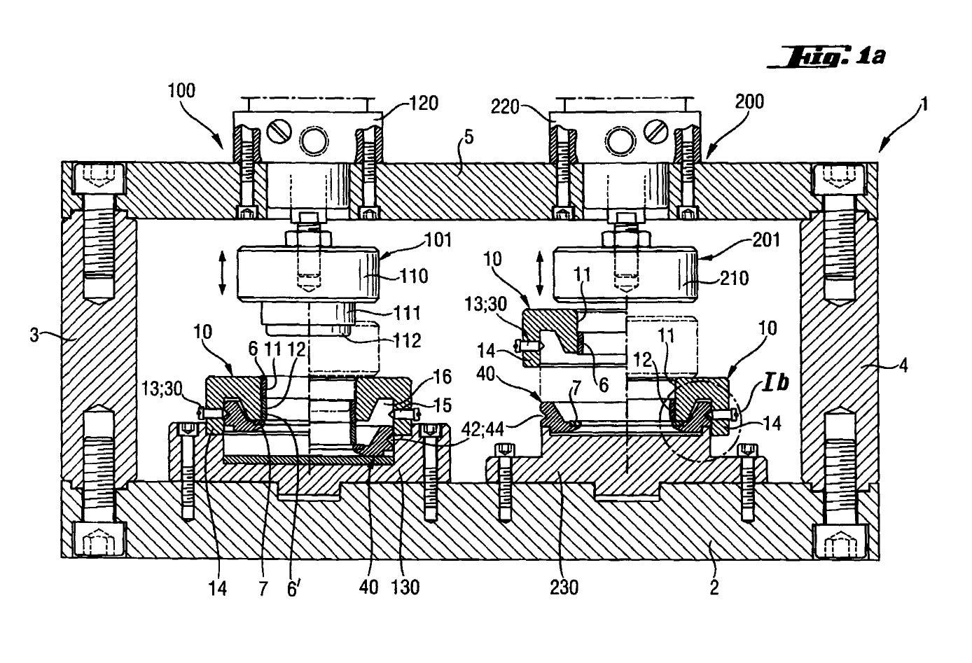

In FIG. 1 press-station 100 and joining-station 200 are represented. This part of the assembly depicts a frame 1 with a base plate 2, supports 3, 4 and a crossbar 5. In the area of the press-station 100 on the base plate 2 a table 130 is accommodated, above which a first press assembly 101 is found, and which is aligned with crossbar 5. This first press assembly 101 exhibits a drive component 120, to move the press bolts 110 in the direction of the arrow up and down.

The press bolts 110 on their large diameter end bear a stamp section 111 and on the small diameter bear a stamp section 112, which are both determined by the diameter of the corresponding component 6, which is located on the first receiver element 10.

A table 230 is found on the base plate 2 in the area of the joining-station 200. A second press assembly 201 is found above the table 230, having a drive assembly 220, to move the press bolts 210 in a vertical direction up and down.

In the press-station 100 is a first receiver element 10 and a second receiver element 40 depicted in cross-section. In the left part of the diagram the two receiver elements 10 and 40 are connected to each other, in the right side the two receiver elements 10 and 40 separated from each other.

The receiver elements 10 and 40 serve to accept a friction bearing socket 6 and a ring fence 7. In the left part of the diagram the press-station 100 is represented in the lower part by a component 6′ comprised of a friction bearing socket 6 and ring fence 7 welded together, upon which the friction bearing socket 6 has been pressed by means of the first press assembly 101. With further pressing of the friction bearing socket 6 this will be pressed downwards within the first receiver element 10, where the finished component 6′ will be pressed out downwards with the second receiver element 40. In this manner the second receiver element 40 will be separated from the first receiver element 10. As is subsequently to be individually described, receiver elements 10 and 40 contain base material 13 and 44 in the form of spring thrust pieces 30 and an circumferential groove 42.

In a process step which is not shown here the finished component 6′ is pressed out of the second receiver element 40.

A second receiver element 40 is found in the joining-station 200 on table 230, in which a ring fence 7 is inserted from above.

The first receiver element 10 with the friction bearing socket 6 from the press-station 100 is placed onto the second receiver element 40, and is pressed against the second receiving element 40 by means of the second press assembly 201 by running the press bolts 210 down. In doing this the base materials 13 and 44 rest against each other. At the same time socket 6, which protrudes slightly against the lower edge of the first receiver element 10 see the left part of the diagram of the joining-station 200, and is pushed back within the first receiving element 10, thereby assuring that the socket 6 lies with its face against ring fence 7.

The detail X drawn in to FIG. 1a is enlarged in FIG. 1b. The first receiver element 10 includes an apron 14, exhibiting a number of bore holes 15 across its surface, into which the first base material 13 spring thrust pieces 30 are arranged, facing to the inside. The second receiver element 40 on its outer circumference 41 exhibits an essentially V-shaped groove 42 as second base material 44. If the first receiving element 10 lies against the second receiver element 40, as represented in FIG. 1b, the spring thrust piece 30 will grip the upper groove lip 43 of groove 42. Thereby creating a vertical force, so that the first receiver element 10 is pressed against the second receiving element 40.

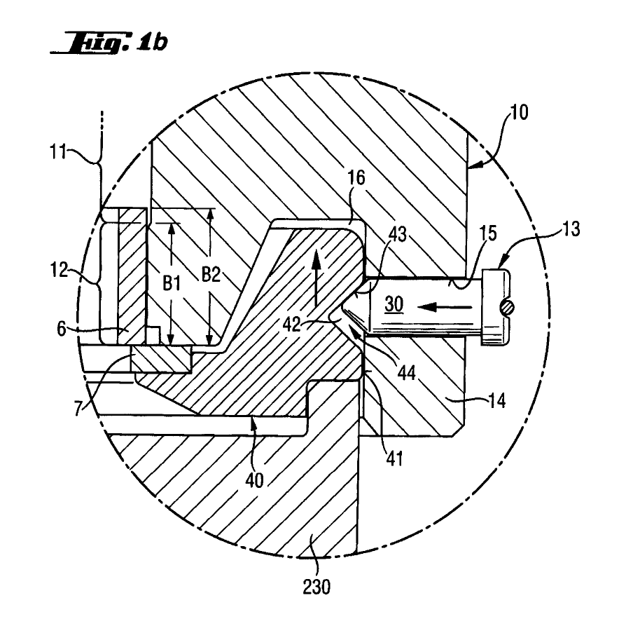

The welding station 300 is represented in FIG. 2, including a rack 301 upon which the motor 310 and a turntable 320 are arranged.

The turntable 320 possesses a tray 321, in which the two interconnected and associated receiver elements 10, 40 are placed. The turntable 320 is suitably configured, so that the interconnection of the two receiver elements 10 and 40 cannot fall apart.

The interconnection of the receiver elements 10 and 40 are on the tray edge 322.

A laser 330 with an optic 331, which emits a laser beam 332 vertically, is attached to rack 301 in the upper area. The axis 325 of the turntables 320 is arranged at a preferred angle of 80° relative to the laser beam 332. The laser beam 332 meets the contact point of friction bearing socket 6 and washer disk 7, so that welding occurs at this area. By turning the turntables 320 by means of the motor 310 the entire inner area is traversed by the laser beam 332.

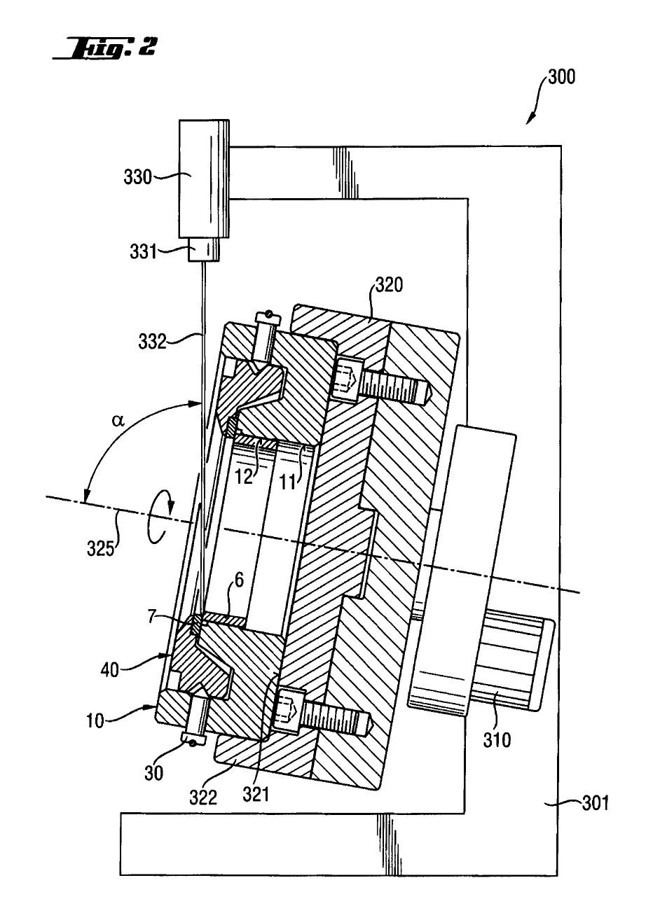

A cross-section view of the first receiver element 10 is presented in FIG. 3. Two receiving sections 11 and 12 are envisioned for core body 19, the diameters of which differ slightly from each other. The diameter of the first receiving section 11 is preferably around 0.4 mm to 0.6 mm, preferably 0.5 mm larger than the diameter of the second receiving section 12, which is arranged beneath the first receiving section 10. In this second receiving section 12 an O-ring 18 is arranged in a corresponding ring nut 17. Thereby ensuring that the not represented friction bearing socket 6 is clamped and held in place in the second receiving section 12, where also concurrently a clearance within the first receiver element 10 is ensured. A ring-shaped apron 14 with bore holes 15 is formed into the core body, into which the spring thrust pieces not represented are to be placed. Through the apron 14 a ring space 16 is formed into which the second receiver element 40 will connect.

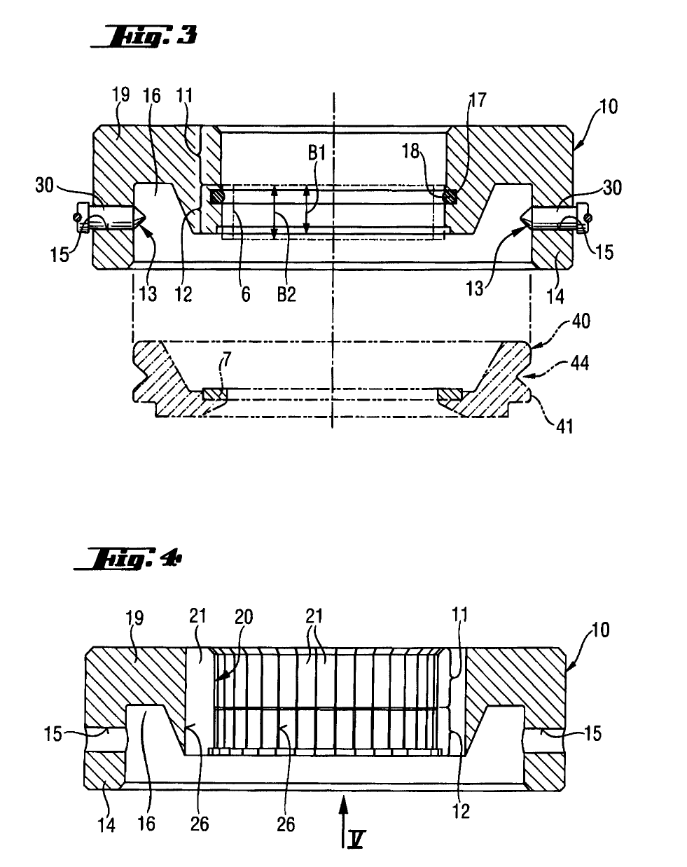

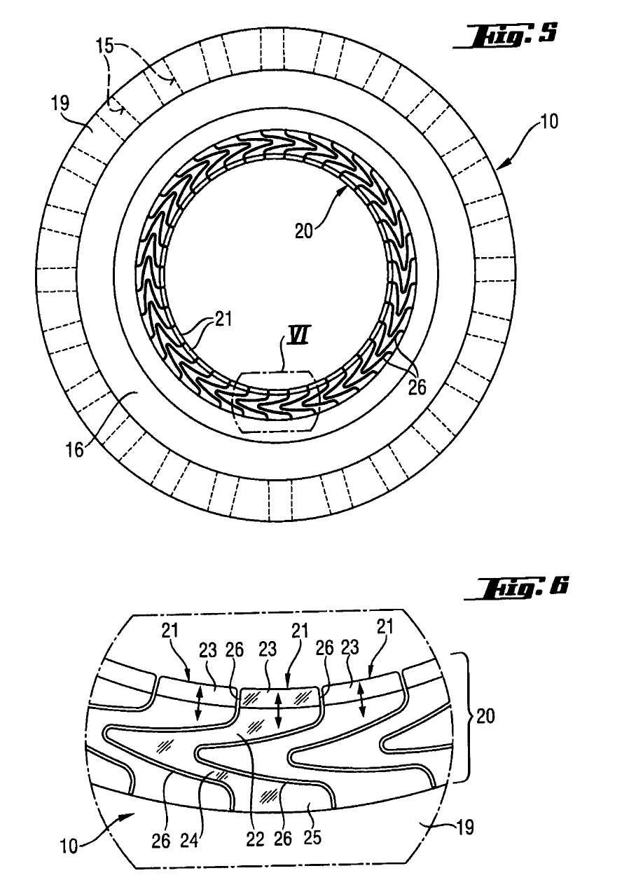

A further implementation form is presented in a cut in FIG. 4, in which the two receiving sections 11 and 12 are formed by a tension ring 20, which is comprised of a number of adjacent arranged spring elements 21, as can be seen in top view in FIG. 5.

FIG. 5 shows a view through receiver element 10 according to FIG. 4 after arrow V. The bore holes 15 in apron 14 are visible for the spring thrust pieces 30 not represented. The tension ring 20 includes a number of adjacent arranged spring elements 21, which are arranged peripherally in rows, having U-shaped implementation.

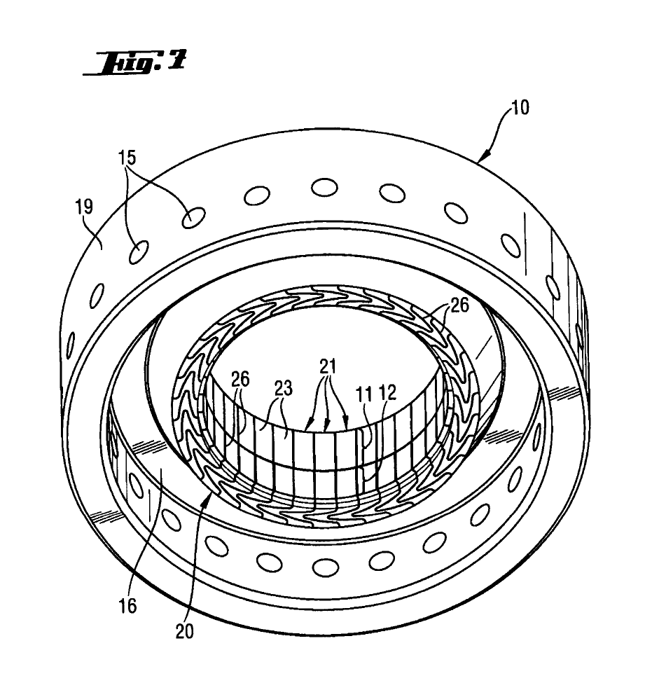

As shown in the enlargement in FIG. 6 detail VI of FIG. 5, each spring thrust piece 21 possesses a first side piece 22 and a second side piece 24, which in top view form a U-shaped spring element 21. The spring elements 21 are separated from each other by a slit 26. The free end 23 of the first side pieces adjoins the not represented friction bearing socket, while the end 25 is attached to the core body 19 of the first receiving section 10. The U-shaped implementation makes possible a spring in a radial direction, as shown in FIG. 6 with the indicated arrows. The width of the tension ring 20 and of the strength of the side piece 22, 24 align themselves according to the desired spring strength.

In FIG. 7 a tension ring 20 is visible in component part perspective. Between the spring elements 21 a slit 26 is present to ensure the necessary mobility for the spring elements.

We claim:

1. Assembly to interconnect at least two components, compromising:
a press-station having at least a first receiver element with a first base material and a first press assembly for pressing a first component into the first receiver element,
a joining-station having a second receiver element with a second base material to accept a second component and with a second pressure assembly to press together and to make a base for the first and second receiver elements and
a welding station for welding the two receiver elements located in the two components.

2. Assembly according to claim 1, wherein thereby characterized, that the base material includes recesses on the receiver element and the spring thrust pieces which connect into the recesses in the other receiver element.

3. Assembly according to claim 1, wherein the first receiver element is a ring-shaped journal bearing receiver and the second receiver element is a ring-shaped thrust bearing receiver.

4. Assembly according to claim 1, wherein the first base material receiver element has a large diameter first receiving section and an adjoining relatively smaller diameter second receiving section.

5. Assembly according to claim 4, wherein the second receiving section has a width B1 that is smaller than a width B2 of the first component.

6. Assembly according to claim 4, wherein the first and second receiving sections are formed in a radial direction and comprise springs.

7. Assembly according to claim 6, wherein the first receiver element comprises a tension ring, having a plurality of interconnecting, adjoining spring elements.

8. Assembly according to claim 6, wherein at least one of the receiving sections includes at least one O-ring.

9. Assembly according to claim 1, wherein the first receiver element includes an apron extending over the second receiver element, in which spring thrust pieces are arranged and pointing inward.

10. Assembly according to claim 9, wherein the second receiving element includes a groove running around its circumference.

11. Assembly according to claim 10, wherein the spring thrust pieces connect on the outside of the second receivers element in the groove.

12. Assembly according to claim 1, wherein the welding station includes a laser.

13. Assembly according to claim 1, wherein the welding station includes a table having a recess into which the interconnecting receiving elements may be placed.

14. Assembly according to claim 13, wherein an axis of the table is suitably configured to have an angle α of between 70° and 95° relative to a beam of the laser.

15. Assembly according to claim 13, wherein the laser is arranged above the table.

16. A receiver element with a core body for clamping acceptance of a receiver component, including at least one receiving section, which is vertical to an outer surface of the to-be-accepted receiver component and including springs having a plurality of interlocking adjacent arranged spring elements.

17. Receiver element according to claim 17, wherein each spring element includes two side pieces, where a free end of a first of side pieces connects to the component and an end of the second side piece is attached to the core body.
